(19) United States
(12) Patent Application Publication
(10) Pub. No.: US 2026/0271982 A1
(43) Pub. Date: Sep. 17, 2026

(54) RECYCLED PUSH WATER SYSTEM FOR CORN REMOVAL

(71) Applicant: Heat and Control, Inc., Flower Mound, TX (US)

(72) Inventors: Victor MANKARIOUS, Flower Mound, TX (US); Rick Wendell BAJEMA, Flower Mound, TX (US); Jonathan Daniel KAYLOR, Flower Mound, TX (US)

(21) Appl. No.: 19/566,762

(22) Filed: Mar. 13, 2026

Related U.S. Application Data
(60) Provisional application No. 63/772,351, filed on Mar. 14, 2025.

(51) Int. Cl. A23N 12/02; B08B 3/14

(52) U.S. Cl. CPC A23N 12/02; B08B 3/14

(57) ABSTRACT

A system for recycling water in a cooking system is provided. The system includes a set of soak tanks, a washer, a skimmer tank, a pump, and a debris removal tank. The set of soak tanks is configured to hydrate a cooked food product and discharge the hydrated cooked food product to the washer via an outlet pipe. The washer is configured to separate the food product and the water and deliver the water to the skimmer tank. The pump delivers the water to the debris removal tank. The debris removal tank is configured to separate debris from the water and deliver the water to the outlet pipe to transfer a hydrated cooked food product to the washer.

### CROSS-REFERENCE TO RELATED APPLICATIONS

This application claims the benefit of provisional U.S. Application No. 63/772,351 entitled “Recycled Push Water System for Corn Removal” filed Mar. 14, 2025, the technical disclosure of which is incorporated herein by reference in its entirety.

### BACKGROUND

### Technical Field

The technical field of the present disclosure relates to industrial food process engineering and, more particularly, to water and energy management in corn processing systems that are common for snack food production.

### Description of Related Art

The corn cooking processes involve a set of kettles to cook corn with a mixture of water and lime, followed by soak tanks to rehydrate the corn, a corn washer to separate the corn from hulls and lime, and a collection box for unwanted debris. This process typically uses a significant amount of water, which is eventually drained. The current technology recirculates a portion of the unwanted water back into the cooking system to minimize water loss. These recirculation systems require multiple pumps combined with separators to perform the recirculation loops. However, these systems face several problems. For example, the separators continuously discharge, leading to unwanted water loss. Additionally, the separators are prone to plugging and require frequent maintenance. Additionally, the complexity of these systems, including multiple pumps, increases capital and energy costs, and the additional components result in a larger footprint. Therefore, a need exists for a circulation system that minimizes unnecessary water loss and decreases operational costs to recycle drainage water in corn cooking processes.

### BRIEF SUMMARY

This summary provides a discussion of aspects of certain embodiments of the invention. It is not intended to limit the claimed invention or any of the terms in the claims. The summary provides some aspects but there are aspects and embodiments of the invention that are not discussed here.

In one aspect, a system for recycling water in a cooking system is provided. The system includes a set of soak tanks, a washer, a skimmer tank, a pump, and a debris removal tank. The set of soak tanks is configured to hydrate a cooked food product and discharge the hydrated cooked food product to the washer via an outlet pipe. The washer is configured to separate the food product from the water and deliver at least a portion of the separated water to the skimmer tank. The pump is fluidly connected to a first outlet of the skimmer tank and delivers the water to the debris removal tank. The debris removal tank is configured to separate debris from the water and deliver the water to an inlet of the outlet pipe to transfer a hydrated cooked food product to the washer.

In one embodiment, the system includes a first valve that is fluidly connected to the first outlet of the debris removal tank, the inlet of the outlet pipe, and a second inlet of the skimmer tank. The first valve can be configured to selectively deliver the water to the outlet pipe to transfer the hydrated cooked food product to the washer or deliver the water to the skimmer tank.

Additionally, the system can include a collection box and a second valve. The debris removal tank can include a debris monitor and a second outlet. The second valve can be fluidly connected to the second outlet of the debris removal tank and a first inlet of the collection box. The second valve can be configured to selectively deliver the separated debris to the collection box when the debris monitor detects a threshold level of debris in the debris removal tank. The debris monitor can include a vibrating fork sensor, a vibrating rod sensor, paddle sensors, a capacitance sensor, ultrasonic sensors, conductivity sensors, or a pressure sensor.

Additionally, the system can also include a third valve having an inlet and an outlet. The inlet is fluidly connected to the first outlet of the skimmer tank, and the outlet is fluidly connected to a second inlet of the collection box. The third valve can be configured to selectively deliver the water to the collection box.

Additionally, the skimmer tank can include a second outlet fluidly connected to the collection box. The skimmer tank can be configured to deliver an excess amount of water to the collection box when a threshold volume is exceeded.

Additionally, the system can include a fourth valve having an inlet and an outlet. The inlet is fluidly connected to a service water source, and the outlet is fluidly connected to a third inlet of the skimmer tank. The fourth valve can be configured to selectively deliver a flow of service water to the skimmer tank.

Additionally, the second valve can be further configured to selectively deliver the separated debris to the collection box when a predetermined period of time has elapsed. The predetermined period of time can be between about 20-60 minutes.

In another embodiment, the debris removal tank includes a housing having a cone-shaped bottom, with the cone-shaped bottom having an angle between about 40 and 70 degrees. The angle of the cone-shaped bottom can also be about 60 degrees.

In another aspect, a system for recycling water in a cooking system is provided. The system includes a set of soak tanks, a washer, a skimmer tank, a pump, a debris removal tank, and a first valve. The set of soak tanks is configured to hydrate a cooked food product and discharge the hydrated cooked food product to the washer via an outlet pipe. The washer is configured to separate the food product from the water and deliver at least a portion of the separated water to the skimmer tank. A pump connected to a first outlet of the skimmer tank delivers the water to a debris removal tank. The debris removal tank receives the water at a first inlet and is configured to separate debris from the water. The first valve includes an inlet, a first outlet, and a second outlet. The inlet is fluidly connected to a first outlet of the debris removal tank, the first outlet is fluidly connected to an inlet of the outlet pipe, and the second outlet is fluidly connected to a second inlet of the skimmer tank. The first valve receives water from the debris removal tank and is configured to selectively deliver the water to the outlet pipe to transfer a hydrated cooked food product to the washer or selectively deliver the water to the skimmer tank.

In one embodiment, the system also includes a collection box and a second valve. The debris removal tank can include a debris monitor and a second outlet. The second valve can be fluidly connected to the second outlet of the debris removal tank and a first inlet of the collection box. The second valve can be configured to selectively deliver the separated debris to the collection box when the debris monitor detects a threshold level of debris in the debris removal tank. The debris monitor can include a vibrating fork sensor, a vibrating rod sensor, paddle sensors, a capacitance sensor, ultrasonic sensors, conductivity sensors, or a pressure sensor.

Additionally, the system can also include a third valve having an inlet and an outlet. The inlet is fluidly connected to the first outlet of the skimmer tank, and the outlet is fluidly connected to a second inlet of the collection box. The third valve can be configured to selectively deliver the water to the collection box.

Additionally, the skimmer tank can include a second outlet fluidly connected to the collection box. The skimmer tank can be configured to deliver an excess amount of water to the collection box when a threshold volume is exceeded.

Additionally, the system can include a fourth valve having an inlet and an outlet. The inlet is fluidly connected to a service water source, and the outlet is fluidly connected to a third inlet of the skimmer tank. The fourth valve can be configured to selectively deliver a flow of service water to the skimmer tank.

Additionally, the second valve can be further configured to selectively deliver the separated debris to the collection box when a predetermined period of time has elapsed. The predetermined period of time can be between about 20-60 minutes.

In another embodiment, the debris removal tank includes a housing having a cone-shaped bottom, with the cone-shaped bottom having an angle between about 40 and 70 degrees. The angle of the cone-shaped bottom can also be about 60 degrees.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1 depicts a simplified process flow diagram of a prior art corn cooking system.

FIG. 2 depicts a simplified process flow diagram of a prior art water recycling system for a corn cooking system.

FIG. 3 depicts a simplified process flow diagram of an improved water recycling system for a corn cooking system.

FIG. 4 depicts a schematic of a first embodiment of an improved water recycling system.

FIG. 5 depicts a schematic of a second embodiment of an improved water recycling system.

FIG. 6 depicts a schematic of a corn removal tank for use in an improved water recycling system for a corn cooking system.

FIGS. 7A and 7B depict schematics of corn removal tanks operating at various sense-based purge thresholds.

FIG. 8 depicts a simplified process flow diagram of an improved corn cooking system.

### DETAILED DESCRIPTION

The present disclosure involves systems and methods that improve the efficiency and sustainability of food industrial processes, including recycling water from washers to the system as push water. The present disclosure provides a more efficient solution to recycling push water than current methods. For example, the disclosed systems and methods can significantly reduce the water and energy inputs to recycle push water in a cooking system by utilizing a novel implementation of a debris removal tank that removes the need for multiple pumps that plagues the current technology and minimizes the needs for an external source of water. The disclosed systems can include timed and sensed purges that can effectively remove debris, ensuring smooth and sanitary operation. The disclosed systems can be integrated with existing programmable logic controllers (PLC) and human-machine interface (HMI) systems, minimizing installation costs. The disclosed systems offer a cost-effective, efficient, and sustainable solution for recycling washer water as push water in a cooking system.

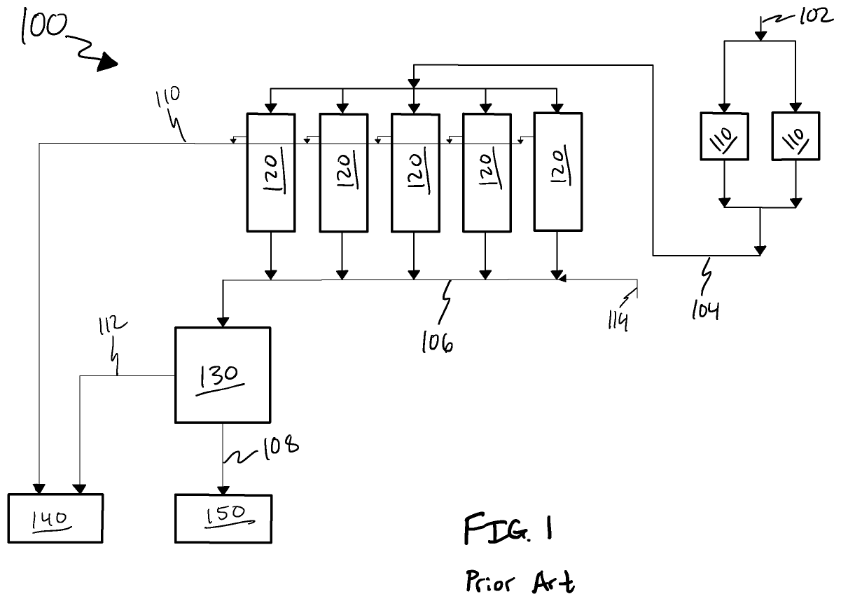

Turning to FIG. 1, a simplified process flow diagram of a prior art corn cooking system 100 is depicted. The corn cooking system includes a set of kettles 110, a set of soak tanks 120, a corn washer 130, a collection box 140, and a mill 150. The set of kettles 110 receive a cooking mixture 102 (e.g., corn and water) to cook the corn for subsequent processing. Additionally, lime can be added directly to the set of kettles 110 for cooking the mixture. The cooked corn mixture 104 is delivered to a set of soak tanks 120 to allow the corn to rehydrate, loosen hulls, and develop flavor. The excess fluid in the soak tanks 120 is drained 110 to the collection box 140, and the hydrated corn mixture 106 is then delivered to a corn washer 130, where the corn is separated from the hulls and lime. The unwanted debris 112 (e.g., hulls and lime) are then delivered to the collection box 140. The separated corn 108 is delivered to the mill 150 for further processing (e.g., baking or frying). An external water source 114 (alternatively known as push water) is used to drive (or transfer) the hydrated corn mixture 106 to the corn washer 130. Given that the process 100 uses a considerable amount of water that is eventually drained, recirculation systems have been utilized to recycle some of this water to push the hydrated corn mixture 106 to the corn washer 130.

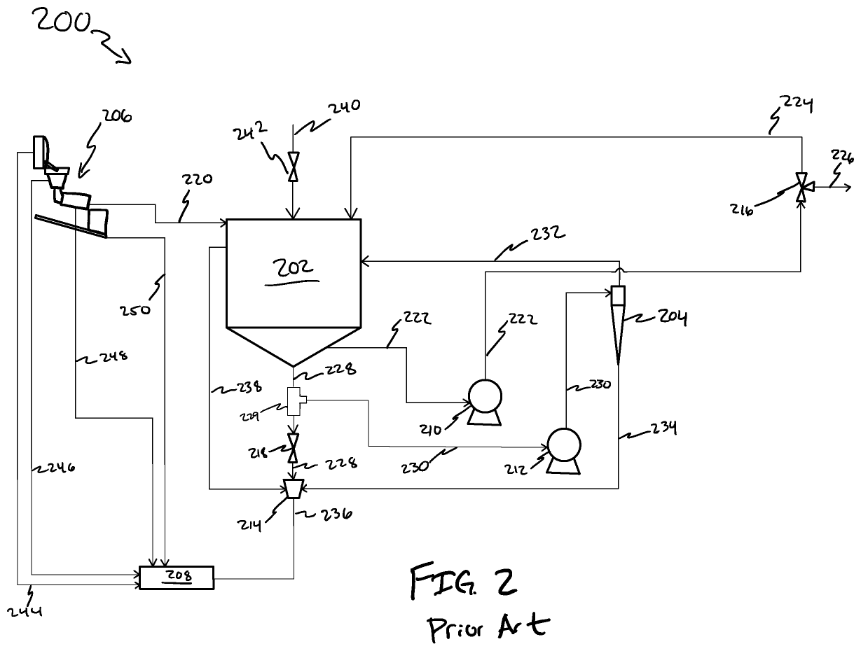

With reference to FIG. 2, a simplified process flow diagram of a prior art water recycling system 200 for a corn cooking system is depicted. The system 200 includes a skimmer tank 202, a cyclone separator 204, a corn washer 206, and a collection box (alternatively referred to as a drainage box, separation box, or duck pond) 208. The corn washer 206 receives hydrated corn from the soak tank (not illustrated), separates a water-broken corn mixture from the corn. For example, the corn washer 206 is configured to divert at least a portion (or all) of the water-broken corn mixture 220 to the skimmer tank 202. Additionally, the corn washer 206 is configured to divert a first portion 244, a second portion 246, a third portion 248, and a fourth portion 250 of the water-broken corn mixture to a collection box 208.

The skimmer tank 202 is configured to drain the water-broken corn mixture 228 to a t-connector 229 that recirculates a portion of the water-broken corn mixture 230 to a cyclone separator 204 for separation. The t-connector 229 is also configured to deliver the water-broken corn mixture 228 to a valve 218 that is configured to selectively transmit the water-broken corn mixture 228 to a junction box 214 to be discharged 236 to the collection box 208. The recirculated water-broken corn mixture 230 is driven to the cyclone separator via a cyclone pump 212. The cyclone separator 204 separates the water from some of the debris (e.g., broken corn particulates) at the bottom of the cyclone separator 204 and recycles the separated water 232 back to the skimmer tank 202. The cyclone separator 204 drains the collected debris (or particulates) 234 to the junction box 214 for drainage 236 to the collection box 208.

The skimmer tank 202 is also configured to transmit the water 222 via a push water pump 210 to a three-way valve 216 for recirculation. The three-way valve 216 is configured to divert the water according to the desired circulation loop. For example, the three-way valve 216 is configured to divert the water 226 to the soak tanks to push the hydrated corn to the corn washer 206. Alternatively, the three-way valve 216 is configured to recycle the water 224 back to the skimmer tank 202 when the cooking system does not require any push water (e.g., there is no hydrated corn to push to the corn washer). A service water valve 242 can be fluidly coupled to the skimmer tank 202 to selectively deliver service water 240 when needed. The skimmer tank 202 is also configured to drain excess water 238 to the junction box 214 when the excess water exceeds a threshold volume in the skimmer tank 202.

Unfortunately, the water recycling system 200 is inefficient and expensive despite being able to repurpose corn washer water that would normally be discarded. For example, the cyclone separator 204 is continuously discharging, which results in unwanted water loss. Additionally, the cyclone separator 204 is prone to plugging from the debris (or particulates) and necessitates system stoppages for maintenance. The process also requires additional capital and energy input, including multiple pump (210, 212) to drive the fluids in the various circulation loops. The additional components also increase the footprint of the system.

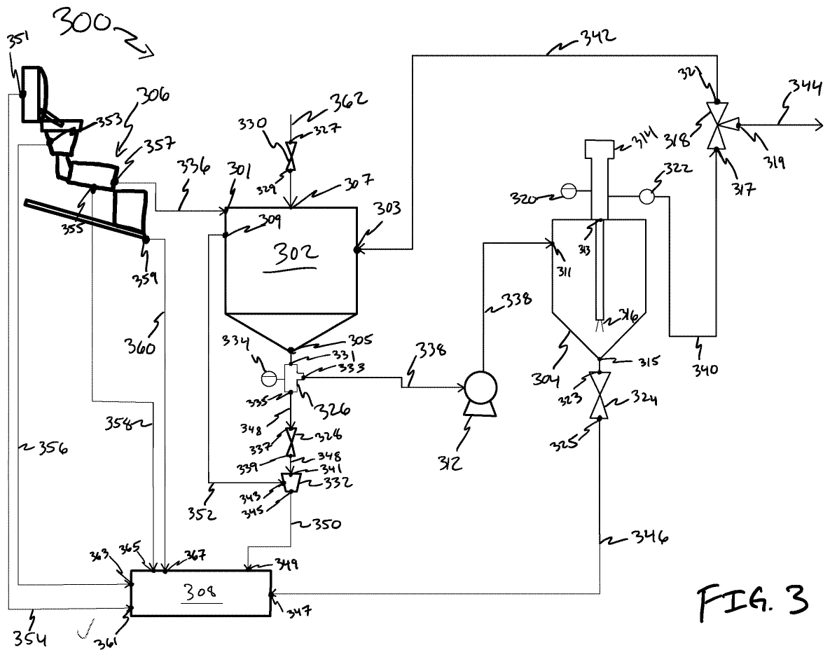

Turning to FIG. 3, a simplified process flow diagram of an improved water recycling system 300 for a corn cooking system is depicted. The water recycling system 300 includes a skimmer tank 302, a corn removal tank (or debris removal tank) 304, a corn washer 306, and a collection box 308. The corn washer 306 receives hydrated corn from the soak tank (not illustrated) and separates a water-broken corn mixture from the corn. For example, the corn washer 306 can be configured to divert at least a portion (or all) of the water-broken corn mixture 336 through a first outlet 357 to a first inlet 301 of the skimmer tank 302. Additionally, the corn washer 306 can be configured to divert another portion of the water-broken corn mixture 354 through a second outlet 351 to a third inlet 361 of the collection box 308. The corn washer 306 can be configured to divert another portion of the water-broken corn mixture 356 through a third outlet 353 to a fourth inlet 363 of the collection box 308. The corn washer 306 can be configured to divert another portion of the water-broken corn mixture 358 through a fourth outlet 355 to a fifth inlet 365 of the collection box 308. The corn washer 306 can be configured to divert another portion of the water-broken corn mixture 360 through a fifth outlet 359 to a sixth inlet 367 of the collection box 308. It is understood that the number of diverted water paths can vary from those depicted in the figures.

After receiving the diverted water-broken corn mixture 336 from the corn washer 306, the skimmer tank 302 is configured to drain the water-broken corn mixture through a first outlet 305 to a first inlet 331 of a t-connector 326. The t-connector 326 can be configured to divert a portion of the water-broken corn mixture for recycling in the system and drainage.

For recycling, the t-connector 326 can be configured to divert the water-broken corn mixture 338 through a first outlet 333 to a pump 312 that is configured to drive the water-broken corn mixture 338 to a first inlet 311 of the corn removal tank 304. The corn removal tank 304 collects the water-broken corn mixture in a housing, allowing the debris (e.g., broken corn particulates) to separate at the bottom of the housing. The recirculated water 340 can be transmitted through a first outlet 313 to a first inlet 317 of a first valve 318. The first valve 318 is configured to selectively deliver the recirculated water 340 to a skimmer recycle line 342 or a push water line 344. The recirculated water 340 may still contain a small amount of corn particles, but the amount is a small (or negligible) enough amount that it will not adversely affect downstream operations (e.g., plugging fluid flow). When the soak tanks (not illustrated) are operational and discharging hydrated cooked corn, the first valve 318 can be configured to deliver the recirculated water 340 through a first outlet 319 to the push water line 344 to drive (or transfer) the discharged hydrated cooked corn to the corn washer 306. The push water line 344 provides a significant benefit of minimizing (or eliminating) the need for an external source of service water to drive the hydrated cooked corn to the corn washer 306. Alternatively, if the soak tanks are not operational, the first valve 318 can be configured to deliver the recirculated water 340 through a second outlet 321 to the skimmer recycle line 342, where the recirculated water 342 enters the skimmer tank 302 via a second inlet 303.

The corn removal tank 304 is configured to discharge the separated debris (or particulates) through a second outlet 315 to a first inlet 323 of a second valve (alternatively referred to as a corn removal drain valve) 324. When actuated, the second valve 324 transmits the separated debris (or particulates) 346 through a first outlet 325 to a first inlet 347 of the collection box 308. The corn removal tank 304 can discharge the separated debris (or particulates) 346 via sensor-based purges, timer-based purges, or a combination thereof. As an example of a sensor-based purge, the corn removal tank 304 can include a debris monitor 314 that is installed into the housing of the corn removal tank 304 and configured to detect a threshold level of debris (or particulates) that have accumulated in the housing. The debris monitor 314 can include a sinking debris monitor 314 that is configured to detect and manage debris that sinks in the fluid contained in the corn removal tank 304. The debris monitor can include vibrating rod sensors, vibrating fork sensors, paddle sensors, capacitance sensor, ultrasonic sensors, optical sensors, conductivity sensors, pressure sensors, or any other sensor known in the art for detecting debris. Examples of timer-based purges can include purging the collected debris when a predetermined period of time has elapsed. A predetermined period of time can be at least 5 minutes, 10 minutes, 15 minutes, 20 minutes, 25 minutes, 30 minutes, 35 minutes, 40 minutes, 45 minutes, 50 minutes, 55 minutes, 60 minutes, between 5-60 minutes, or any combination thereof.

In one embodiment, the debris monitor 314 can be a vibrating level switch that is configured to detect granulated bulk solids in the housing. For example, the debris monitor 314 can be a vibrating fork that is configured to accurately detect particulates having a first threshold density (e.g., at least 5 g/l, at least 8 g/l, etc.), increasing the efficiency of the system. Alternatively, the debris monitor 314 can be a vibrating switch (or rod) that is configured to accurately detect particulates having a second threshold density (e.g., at least 15 g/l, at least 20 g/l, etc.), increasing the efficiency of the system. One example of the vibrating level switches can include VEGAVIB or VEGAWAVE detectors that detect a threshold level (e.g., a minimum limit level of debris, a maximum limit level of debris, or a combination thereof) that triggers the second valve 324 to discharge the debris-filled mixture 346. In one embodiment, the debris monitor 314 preferably utilizes a vibrating fork 316 to detect the debris (or particulates) because the consistency of the solids present in the water diverted from the corn washer are most accurately detected via tuning rods. However, it should be understood that the debris monitor 314 can be of any type known in the art. The threshold level can be set to any level of the housing, including between 0-99% of the capacity, 10-90%, 20-80%, 30-70%, 40-60%, or any combination thereof. In the illustrative embodiment, the distance between the terminal end of the debris monitor 314 and the bottom of the housing corresponds to the threshold level of the debris. The corn removal tank 304 can also include a level transmitter (not illustrated) that is configured to transmit the level of the fluid, debris, or a combination thereof to a processor (not illustrated) for monitoring the fluid operation within the corn removal tank 304.

The corn removal tank 304 can be configured to be pressurized to facilitate driving the fluid through the outlets (313, 315). The corn removal tank 304 can also be equipped with instrumentation to monitor the fluid properties in the housing and flowing out of the corn removal tank 304. For example, the corn removal tank 304 can include a pressure indicator 320 and a flow meter 322 to monitor the recycled water flow rate. The pressure indicator 320 is configured for measuring the pressure in the corn removal tank 304. Optionally, the corn removal tank can include a pressure relief valve (not illustrated) to be opened if the pressure in the corn removal tank 304 exceeds a threshold level. The readings from the flow meter 322 can be used by a control system to control the speed of the pump 312.

If the cooking system does not need any recycled fluid, the t-connector 326 can be configured to drain the excess water 348 through a second outlet 335 to a first inlet 337 of a third valve (alternatively referred to as a drain valve) 328. The third valve 328 can transmit the excess fluid 348 through a first outlet 339 to a first inlet 341 of a junction box 332 for discharge. The t-connector 326 can also include a pressure indicator 334 that can cause the third valve 326, the pump 312, or a combination thereof to adjust the flow of the water-broken corn mixture 338.

The skimmer tank 302 can also be configured to purge excess fluid 352 when a threshold volume is exceeded. For example, when fluid fills the skimmer tank above a threshold level, the skimmer tank 302 can purge the excess fluid 352 through a second outlet 309 to a second inlet 343 of the mixer 332. The junction box 332 can drain the combined purge flow 350 through an outlet 345 to a second inlet 349 of the collection box 308. The skimmer tank 302 is also configured to receive a supply of service water 362 when an additional amount of water is needed to execute the various circulation loops. In the illustrative embodiment, a fourth valve 330 is configured to selectively deliver a flow of service water 362 to the skimmer tank 302. The service water 362 enters an inlet 327 of the fourth valve 330 and is outputted through an outlet 329 and into a third inlet 307 of the skimmer tank 302.

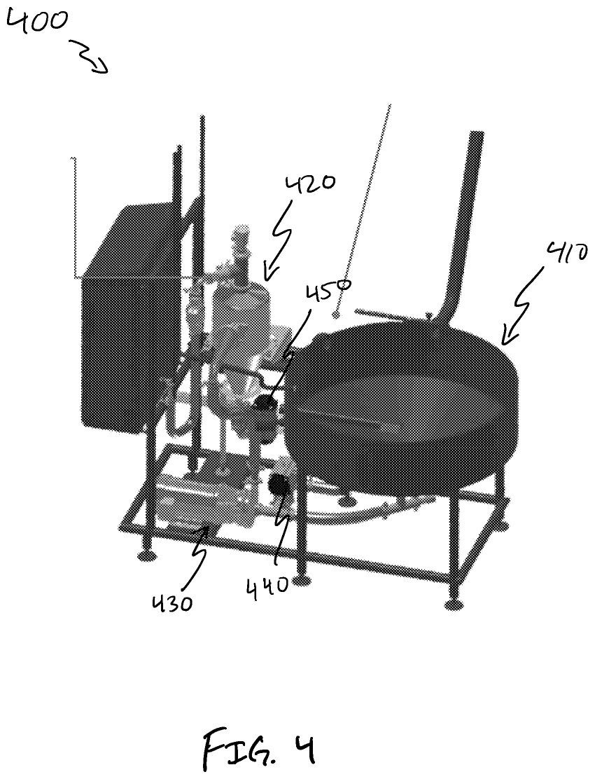

Turning to FIG. 4, a schematic of a first embodiment of an improved water recycling system 400 is depicted. The water recycling system 400 includes a skimmer tank 410, a corn removal tank 420, a pump 430, a skimmer drain valve 440, and a corn removal tank drain valve 450. In the illustrative embodiment, an existing skimmer tank 410 is retrofitted (or reconfigured) to operate with the corn removal tank 420 and execute the various circulation loops described herein. The illustrative embodiment advantageously allows users to integrate the corn removal tank 420 into their current system, minimizing costs and installation time to perform the described water recycling techniques.

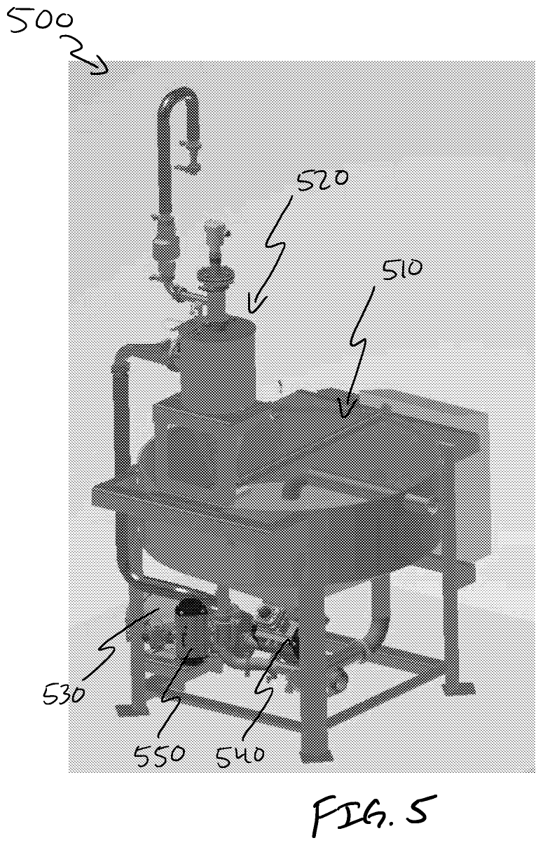

With reference to FIG. 5, a schematic of a second embodiment of an improved water recycling system 500 is depicted. The water recycling system 500 includes a skimmer tank 510, a corn removal tank 520, a pump 530, a skimmer drain valve 540, and a corn removal tank drain valve 550. In the illustrative embodiment, a new skimmer tank 510 and corn removal tank 520 package are provided. The water recycling system 500 offers a significantly smaller footprint than retrofitted skimmer tanks (e.g., FIG. 4). In addition to providing a more space efficient process, the compact water recycling system 500 configuration advantageously provides cost savings (e.g., construction and installation), better energy efficiency, and flexible scalability.

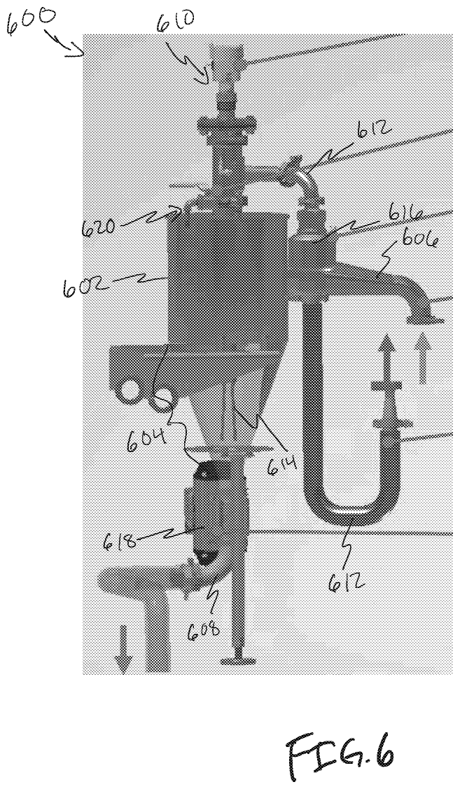

Turning to FIG. 6, an embodiment of a corn removal tank 600 is depicted. The corn removal tank 600 includes a housing 602 configured to contain recycled water. The housing 602 includes a funnel (or cone-shaped bottom) 604 that is configured to receive debris (or particulates) the recycled water contains. The recycled water enters the housing 602 from an inlet pipe 606 that is fluidly connected to a skimmer tank (not illustrated). The housing 602 is typically pressurized, which drives the filtered water out of the housing 602 to an outlet pipe 612 that is fluidly connected to the soak tanks (not illustrated), the skimmer tank, or a combination thereof. The corn removal tank 600 includes a drain valve 618 that is configured to selectively drain the collected debris through an outlet pipe 608 via sensed-based purges, time-based purges, or a combination thereof. The corn removal tank 600 includes a debris monitor 610 that is installed into the housing 602 and configured to detect a threshold level of debris in the housing 602. In the illustrative embodiment, the debris monitor 610 includes a vibrating fork 614 that is adapted to detect the minimum level of debris, maximum level of debris, or a combination thereof. Vibrating forks 614 are advantageously utilized for detecting fine-grained bulk solids with low density, which is common for debris being recycled from corn washers in corn cooking process. However, alternate debris monitors 610 (e.g., vibrating rods) can be utilized with the corn removal tank 600 to perform the disclosed functions. Additionally, or alternatively, the drain valve 618 can be configured to drain the debris based on an elapsed time of a timer (not illustrated). For example, the drain valve 618 can be configured to purge every 5 minutes, 10 minutes, 15 minutes, 20 minutes, 25 minutes, 30 minutes, 35 minutes, 40 minutes, 45 minutes, 50 minutes, 55 minutes, 60 minutes, 5-60 minutes, 20-30 minutes, 30-45 minutes, 45-60 minutes, or any combination thereof. The various purging techniques significantly decreases the amount of water that is wasted and reduces (or eliminates) the drain plugging that plagues the prior art devices. The corn removal tank 600 can also include a vent 620 (manual or automated) and a flow meter 616 (to measure the flow rate of the fluid). Optionally, the corn removal tank 600 can include a pressure relief valve that can be opened when a threshold pressure level is exceeded in the corn removal tank 600.

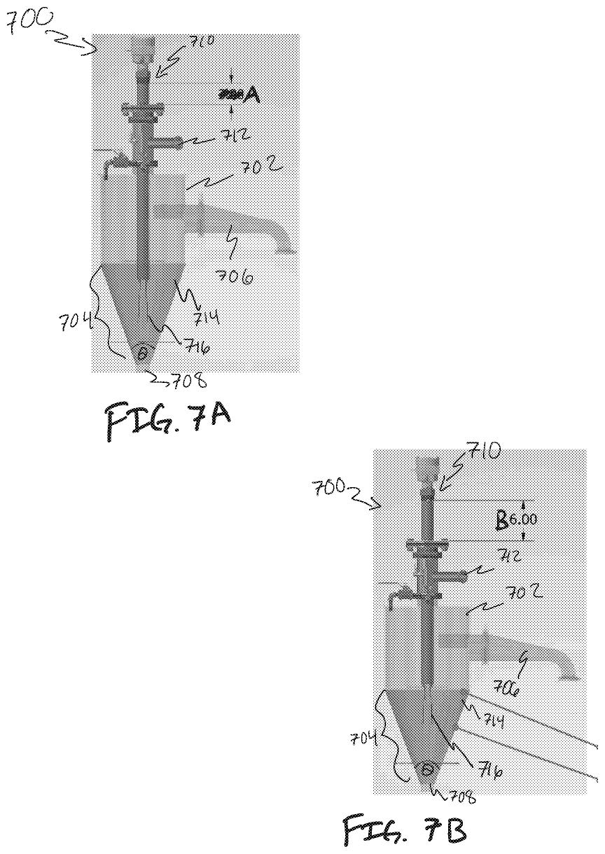

With reference to FIGS. 7A and 7B, schematics of corn removal tanks 700 operating at various sense-based purge thresholds. The corn removal tanks 700 include a housing 702 that is configured to receive water from an inlet pipe 706. The housing 702 is adapted to separate the debris (or particulates) 714 in the water at the funnel (or cone-shaped bottom) 704 of the housing. The separated water is outputted through an outlet pipe 712 that is fluidly connected to the soak tanks (not illustrated), the skimmer tank (not illustrated), or a combination thereof. The corn removal tanks 700 include a debris monitor 710 utilizing a vibrating fork 716. As described herein, the tuning fork 716 detects a threshold level of particulates that have collected in the housing 702. Once the threshold level of particulates is detected, a drain valve (not illustrated) is opened and the particulates are purged through a drain 708 in the housing 702. In FIG. 7A, the debris monitor 710 is configured to detect particulates at a first level and is raised to a height A. In FIG. 7B, the debris monitor 710 is configured to detect particulates at a second level and is raised to a height B, which corresponds to a higher level detection and greater accumulation amount of particulates in the housing 702. The funnel 704 can be sized and configured to have an angle 0 between about 40 and 70 degrees. In a preferred embodiment, the funnel 704 has an angle 0 of about 60 degrees. The disclosed funnel 704 angles 0 advantageously decrease (or prevent) the housing 702 from becoming plugged and preventing any purging through the drain 708.

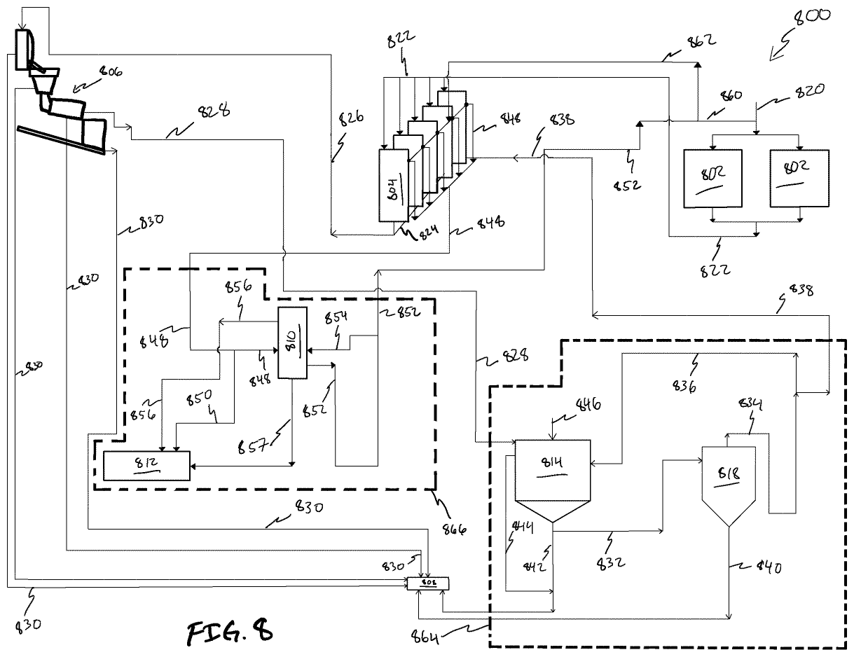

Turning to FIG. 8, a simplified process flow diagram of an improved corn cooking system 800 is depicted. In the illustrative embodiment, the disclosed corn removal sub-system 864 is optionally integrated with an overflow sub-system 866 to optimize a corn cooking system 800. The corn cooking system 800 includes a set of kettles 802, a set of soak tanks 804, a corn washer 806, a drainage box (or collection box) 808, an overflow tank 810, a collection box 812, a skimmer tank 814, and a corn removal tank 818. It is understood that the number of components can vary than depicted in the illustrative embodiment. The set of kettles 802 are configured to receive a cooking mixture 820 that can include corn, water, and lime. Once sufficiently cooked, the cooked mixture product 822 can be delivered to the set of soak tanks 804 to allow the corn to rehydrate, loosen hulls, and develop flavor. The hydrated corn mixture 826 can be delivered to a corn washer 806, where the corn is separated from the hulls and lime. The set of soak tanks 804 are configured with overflow piping 848 that allows excess fluid to be diverted to the overflow tank 810 instead of being drained off as waste. The excess fluid can comprise a water-broken corn mixture.

### Overflow Sub-System

The overflow tank 810 is be configured to output the excess fluid 852 for various circulation loops in the system 800. The overflow tank 810 can be configured for a cooking loop wherein the excess fluid 852 is transported out of the overflow tank 810 and recycled 860 back to the set of kettles 802 for subsequent cooking. The cooking loop provides the added benefits of minimizing (or eliminating) the need for fresh water supply to cook the corn in the kettles 802. Additionally, the recycled water contains lime from previous cooking cycles and advantageously decreases the need to add lime to the kettles 802 for cooking.

In another example, the overflow tank 810 can be configured to output 852 the excess fluid for an agitation loop to prevent fouling within the overflow tank 810. After the overflow tank 810 outputs 852 the excess fluid, an agitation valve (not illustrated) diverts 854 the excess fluid back to the overflow tank 810 where agitation nozzles (not illustrated) agitate the excess fluid stored in the overflow tank 810, which prevents the particulates from settling and fouling the overflow tank (e.g., lime build-up in the interior of the overflow tank), and increases the sanitation of the process 800.

The overflow tank 810 can also be configured to output 852 a cleaning solution for a sanitizing loop to clean the overflow piping 848. A cleaning solution can be dumped into the overflow tank 810, which outputs 852 the cleaning solution to a fill valve (not illustrated), where the cleaning solution is diverted 862 to the overflow piping 848 for cleaning, enhancing the sanitation of the system 800. The sanitizing loop is preferably performed as a low-level sanitization loop that does not require the soak tanks 804 to be completely filled. Thus, the sanitizing loop advantageously utilizes a smaller amount of energy and resources to sanitize the overflow piping.

The overflow tank can also be configured to divert the excess fluid to the collection box 812 to avoid the build-up of debris in the overflow tank 810. For example, before the excess fluid 848 enters the overflow tank 810, the excess fluid can be diverted 850 to the collection box 812. This diverted flow pattern 850 can be utilized in situations where there might be a malfunction in the system 800 and the water needs to be discharged from the system 800. The overflow tank 810 can be configured to determine a threshold amount of debris that has been collected in the overflow tank 810 and drain the debris 857 to the collection box 812. The overflow tank 810 can be configured to drain the excess fluid 856 upon the excess fluid 856 exceeding a threshold level in the overflow tank 810.

### Corn Removal Sub-System

The corn washer 806 is configured to divert portions of a water-broken corn mixture 830 to a drainage box 808. The corn washer 806 is also configured to divert a portion of the water-broken corn mixture 828 to the skimmer tank 814 for recycling. The skimmer tank 814 is configured to drain the water-broken corn mixture to a t-connector (not illustrated) that is configured to selectively deliver the excess water for recycling in the system or drainage.

For recycling the excess water, the t-connector can be configured to divert the water-broken corn mixture 832 to the corn removal tank 818. The particulates in the water-broken corn mixture settle at the bottom portion of the corn removal tank 818 while the separated water is transmitted to a valve (not illustrated), which is configured to selectively deliver the excess fluid 834 to a skimmer recycle line 836 or a push water line 838. When the soak tanks 804 are operational and discharging hydrated cooked corn, the push water line 838 delivers the fluid to the push flow piping 824 that is in fluid communication with the drains of each of the soak tanks 804. The push flow fluid advantageously drives the discharged hydrated cooked corn 826 to the corn washer 806 instead of relying on an external source of water. Alternatively, if the soak tanks 804 are not operational, the valve can be configured to deliver the excess water 834 to the skimmer tank 814 via the skimmer recycle line 836. The corn removal tank 814 is configured to discharge the separated debris (or particulates) 840 through a drain valve (not illustrated) to the collection box 808 in response to sense-based purges, time-based purges, or a combination thereof.

If the cooking system 800 does not need any recycled fluid, the t-connector can be configured to drain the water-broken corn mixture 842 through a drain valve (not illustrated) to the collection box 808. The skimmer tank 814 can also be configured to purge excess fluid 844 to the collection box 808 when an excess volume in the skimmer tank 814 is exceeded. Optionally, the skimmer tank 814 can be configured to receive a flow of service water 846 from an external source.

As used herein, the term “about” can be understood as the disclosed values varying by 20-25%, 15-20%, 10-15%, 5-10%, 1-5%, or any combination thereof from the listed values.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that a particular technology is prior art to any embodiment(s) in this disclosure. Neither is the “Summary” a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. A system for recycling water in a corn cooking system, the system comprising:
a set of soak tanks configured to hydrate a cooked corn product, wherein the set of soak tanks comprise an outlet pipe to discharge the hydrated cooked corn product;
a corn washer fluidly connected to the outlet pipe of the set of soak tanks and configured to receive the hydrated corn product, wherein the corn washer is further configured to separate corn from water;
a skimmer tank fluidly connected to the corn washer and configured to receive at least a portion of the separated water at a first inlet;
a pump fluidly connected to a first outlet of the skimmer tank and configured to receive the water; and
a corn removal tank fluidly connected to the pump and configured to receive the water at a first inlet, wherein the corn removal tank is further configured to separate debris from the water and deliver the water through a first outlet to an inlet of the outlet pipe to transfer hydrated cooked corn product to the corn washer.

2. The system of claim 1, further comprising a first valve fluidly connected to the first outlet of the corn removal tank, the inlet of the outlet pipe, and a second inlet of the skimmer tank, wherein the first valve is configured to:
selectively deliver the water to the outlet pipe to transfer the hydrated cooked corn product to the corn washer; or
selectively deliver the water to the skimmer tank.

3. The system of claim 2, further comprising a collection box and a second valve, wherein:
the corn removal tank further comprises a debris monitor and a second outlet;
the second valve is fluidly connected to the second outlet of the corn removal tank and a first inlet of the collection box; and
the second valve is configured to selectively deliver the separated debris to the collection box when the debris monitor detects a threshold level of debris in the corn removal tank.

4. The system of claim 1, wherein the corn removal tank comprises a housing having a cone-shaped bottom, further wherein the cone-shaped bottom has an angle between about 40 and 70 degrees.

5. The system of claim 4, wherein the angle of the cone-shaped bottom is about 60 degrees.

6. The system of claim 3, further comprising a third valve having an inlet and an outlet, the inlet is fluidly connected to the first outlet of the skimmer tank, and the outlet is fluidly connected to a second inlet of the collection box, wherein the third valve is configured to selectively deliver the separated water to the collection box.

7. The system of claim 6, wherein the skimmer tank comprises a second outlet fluidly connected to the collection box, wherein the skimmer tank is configured to deliver an excess amount of water to the collection box when a threshold volume is exceeded.

8. The system of claim 7, further comprising a fourth valve having an inlet and an outlet, wherein the inlet is fluidly connected to a service water source, and the outlet is fluidly connected to a third inlet of the skimmer tank, and wherein the fourth valve is configured to selectively deliver a flow of service water to the skimmer tank.

9. The system of claim 3, wherein the second valve is further configured to selectively deliver the separated debris to the collection box when a predetermined period of time has elapsed.

10. The system of claim 9, wherein the predetermined period of time is between about 20-60 minutes.

11. The system of claim 3, wherein the debris monitor comprises a vibrating fork sensor, a vibrating rod sensor, paddle sensors, a capacitance sensor, ultrasonic sensors, conductivity sensors, or a pressure sensor.

12. A system for recycling water in a corn cooking system, the system comprising:
a set of soak tanks configured to hydrate a cooked corn product, wherein the set of soak tanks comprise an outlet pipe to discharge the hydrated cooked corn product;
a corn washer fluidly connected to the outlet pipe of the set of soak tanks and configured to receive the hydrated corn product, wherein the corn washer is further configured to separate corn from water;
a skimmer tank fluidly connected to the corn washer and configured to receive at least a portion of the separated water at a first inlet;
a pump fluidly connected to a first outlet of the skimmer tank and configured to receive the water;
a corn removal tank fluidly connected to the pump and configured to receive the water at a first inlet, wherein the corn removal tank is further configured to separate debris from the water;
a first valve comprising an inlet, a first outlet, and a second outlet, wherein the inlet is fluidly connected to a first outlet of the corn removal tank, the first outlet is fluidly connected to an inlet of the outlet pipe, and the second outlet is fluidly connected to a second inlet of the skimmer tank;
wherein the first valve receives water from the corn removal system and is configured to:
selectively deliver the water to the outlet pipe to transfer hydrated corn product to the corn washer, or selectively deliver the water to the skimmer tank.

13. The system of claim 12, further comprising a collection box and a second valve, wherein:
the corn removal tank further comprises a debris monitor and a second outlet;
the second valve fluidly is fluidly connected to the second outlet of the corn removal tank and a first inlet of the collection box; and
the second valve is configured to selectively deliver the separated debris to the collection box when the debris monitor detects a threshold level of debris in the corn removal tank.

14. The system of claim 12, wherein the corn removal tank comprises a housing having a cone-shaped bottom, further wherein the cone-shaped bottom has an angle between about 40 and 70 degrees.

15. The system of claim 14, wherein the angle of the cone-shaped bottom is about 60 degrees.

16. The system of claim 13, further comprising a third valve having an inlet and an outlet, the inlet is fluidly connected to the first outlet of the skimmer tank, and the outlet is fluidly connected to a second inlet of the collection box, wherein the third valve is configured to selectively deliver the water to the collection box.

17. The system of claim 16, wherein the skimmer tank comprises a second outlet fluidly connected to the collection box, wherein the skimmer tank is configured to deliver an excess amount of water to the collection box when a threshold volume is exceeded.

18. The system of claim 17, further comprising a fourth valve having an inlet and an outlet, wherein the inlet is fluidly connected to a service water source, and the outlet is fluidly connected to a third inlet of the skimmer tank, and wherein the fourth valve is configured to selectively deliver a flow of service water to the skimmer tank.

19. The system of claim 13, wherein the second valve is further configured to selectively deliver the separated debris to the collection box when a predetermined period of time has elapsed.

20. The system of claim 19, wherein the predetermined period of time is between about 20-60 minutes, and wherein the debris monitor comprises a vibrating fork sensor, a vibrating rod sensor, paddle sensors, a capacitance sensor, ultrasonic sensors, conductivity sensors, or a pressure sensor.
